(19) United States
(12) Patent Application Publication
(10) Pub. No.: US 2025/0387814 A1
(43) Pub. Date: Dec. 25, 2025

(54) PIPE CLEANING DEVICE USING ROTATING BRUSH

(71) Applicant: Samsung Electronics Co., Ltd., Suwon-si (KR)

(72) Inventors: Byeongchan JEONG, Suwon-si (KR); Hyoukryeol CHOI, Suwon-si (KR); Dongyoung LEE, Suwon-si (KR); Jaehyuk HUR, Suwon-si (KR)

(73) Assignees: Samsung Electronics Co., Ltd., Suwon-si (KR); RESEARCH & BUSINESS FOUNDATION SUNGKYUNKWAN UNIVERSITY, Gyeonggi-do (KR)

(21) Appl. No.: 19/002,010

(22) Filed: Dec. 26, 2024

(30) Foreign Application Priority Data
Jun. 25, 2024 (KR) 10-2024-0083034

(51) Int. Cl. B08B 9/055

(52) U.S. Cl. CPC B08B 9/0553

(57) ABSTRACT

A pipe cleaning device includes a main body, a brush module including a plurality of brushes and a plurality of connecting members, a gear box, and a driving module. The gear box includes an input gear, a stationary gear, a plurality of output gears, and a plurality of driven gears. The plurality of output gears form a first meshing with the input gear and form a second meshing with the stationary gear. Each of the plurality of driven gears form a third meshing with a corresponding one of the plurality of output gears. Each of the plurality of brushes rotates in a same rotational direction and at a same angular velocity as the plurality of driven gears, and orbits in a same direction and at a same angular velocity as the plurality of driven gears.

### CROSS-REFERENCE TO RELATED APPLICATION

This application claims priority under 35 U.S.C. § 119 to Korean Patent Application No. 10-2024-0083034, filed on Jun. 25, 2024, in the Korean Intellectual Property Office, the disclosure of which is incorporated by reference herein in its entirety.

### BACKGROUND

Some example embodiments relate to a pipe cleaning device cleaning a pipe by using a plurality of brushes that rotate and move in an orbital motion.

Piping is used in industrial sites to transport various gases and fluids. Gases and fluids flowing inside a pipe may form residue on the inner wall of the pipe through physical and/or chemical reactions.

To remove and/or dislodge residue that has formed on the inner walls of pipes, workers can clean the inside of the pipes. However, if the pipes are installed at high locations and/or hazardous or toxic residue such as hydrofluoric acid has formed on the inner walls of the pipes, the workers may be exposed to an unsafe and/or dangerous work environment.

### SUMMARY

Some example embodiments of the inventive concepts provide a pipe cleaning device for more effectively removing residue deposited on the inner wall of a pipe.

According to some example embodiments, a pipe cleaning device includes a main body configured to move within a pipe in an axial direction of the pipe, a brush module at a front of the main body, and including a plurality of brushes and a plurality of connecting members, a gear box between the main body and the brush module, and a driving module at least partially within the main body and configured to provide a rotational driving force to the gear box. The gear box includes an input gear, a stationary gear, a plurality of output gears, and a plurality of driven gears, the input gear configured to rotate based on the rotational driving force received from the driving module. The plurality of output gears are configured to form a first meshing with the input gear and form a second meshing with the stationary gear, and the plurality of output gears are configured to rotate in response to power received from the input gear based on the first meshing, and are configured to orbit about the main body based on the second meshing and the rotation of the plurality of output gears. Each of the plurality of driven gears is configured to form a third meshing with a corresponding one of the plurality of output gears and is configured to receive power from a corresponding one of the plurality of output gears based on the third meshing to rotate and move orbitally. Each of the plurality of brushes is configured to connect using a corresponding one of the plurality of connecting members to a corresponding one of the plurality of driven gears, rotate in the same rotational direction and at the same angular velocity as the plurality of driven gears, and orbit in the same rotational direction and at a same angular velocity as the plurality of driven gears.

According to some example embodiments, a pipe cleaning device includes a main body configured to move within a pipe in an axial direction of the pipe and having a central axis coinciding with a central axis of the pipe, a gear box coupled to an end of the main body, a brush module at a front end of the gear box, and including a plurality of brushes, a first connecting member, a second connecting member, and a brush support plate, and a driving module configured to provide a rotational driving force to the gear box and located at least partially within the main body. The gear box includes an input gear, a stationary gear, a plurality of output gears, and a plurality of driven gears, and the input gear is configured to rotate based on the rotational driving force received from the driving module. Each of the plurality of output gears are configured to form a first meshing with the input gear and form a second meshing with the stationary gear, and each of the plurality of output gears rotates based on the first meshing, and moves orbitally based on the second meshing and the rotation of the plurality of output gears. Each of the plurality of driven gears is configured to form third meshing with a corresponding one of the plurality of output gears and receive power from the plurality of output gears to rotate and move orbitally. The first connecting member is configured to form a first connection between one end of each of the plurality of brushes and each of the plurality of driven gears, and the second connecting member is configured to form a second connection between another end of each of the plurality of brushes and the brush support plate. Each of the plurality of brushes is configured to rotate in the same rotational direction and at the same angular velocity as the plurality of driven gears, and is configured to move in an orbital motion in the same direction and at the same angular velocity as the plurality of driven gears.

According to some example embodiments, a pipe cleaning device includes a main body configured to be located within the pipe and having a central axis coinciding with a central axis of the pipe, a traveling module configured to move the main body in an axial direction of the pipe, a brush module in a front of the main body, and including a plurality of brushes, a first connecting member, a second connecting member, and a brush support plate, a gear box connected to the front of the main body and a rear of the brush module, and a driving module at least partially within the main body and configured to provide a rotational driving force to the gear box. The gear box includes a stationary plate, a sun gear, a ring gear, a plurality of planetary gears, and a plurality of driven gears. The stationary plate is coupled to a front of the main body and stationary. The ring gear is on an inner circumferential surface of a protrusion of the stationary plate and is stationary. The sun gear is connected to the driving module by a rotating shaft passing through the fixed plate, and the sun gear is configured to rotate based on the rotating driving force. The plurality of planetary gears are configured to form a first meshing with the sun gear and a second meshing with the ring gear, rotate based on the first meshing, and move in an orbital motion based on the rotation of the plurality of planetary gears and the second meshing. Each of the plurality of driven gears form third meshing with a corresponding one of the plurality of planetary gears, and receive power from the plurality of planetary gears to rotate and move in an orbital motion. The first connecting member is configured to form a first connection between one end of each of the plurality of brushes and each of the plurality of driven gears, and the second connecting member forms a second connection between another end of each of the plurality of brushes and the brush support plate. Each of the plurality of brushes is configured to rotate in the same direction and at the same angular velocity as the plurality of driven gears, and move in orbital motion in the same rotational direction and at the same angular velocity as the plurality of driven gears.

### BRIEF DESCRIPTION OF THE DRAWINGS

Example embodiments will be more clearly understood from the following detailed description taken in conjunction with the accompanying drawings in which:

FIG. 1 is a perspective view of a pipe cleaning device, according to some example embodiments.

FIG. 2 is a cross-sectional view of the pipe cleaning device in a Y-axis direction in FIG. 1, according to some example embodiments.

FIG. 3 is a schematic cross-sectional view in an X-axis direction in FIG. 1 of the pipe cleaning device located in the pipe, according to some example embodiments.

FIG. 4 is a cut-out perspective view of a gear box of a pipe cleaning device, according to some example embodiments.

FIG. 5 is a cross-sectional view of the gear box of the pipe cleaning device in the Y-axis direction, according to some example embodiments.

FIG. 6 is a perspective view showing angles of a first connection and a second connection of the pipe cleaning device, according to some example embodiments.

### DETAILED DESCRIPTION

As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C,” “at least one of A, B, or C”) may be construed as A only, B only, C only, or any combination of two or more of A, B, and C, such as, for instance, ABC, AB, BC, and AC.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

Example embodiments will now be described with reference to the accompanying drawings. In the accompanying drawings, like reference numerals may refer to like elements, and descriptions thereof may not be repeated.

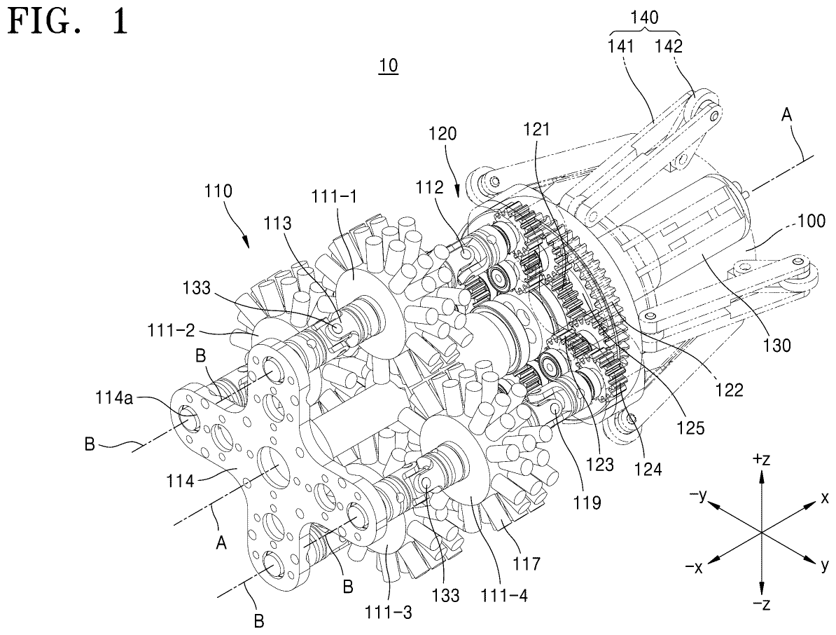

FIG. 1 is a perspective view of a pipe cleaning device 10, according to some example embodiments.

Referring to FIG. 1, the pipe cleaning device 10 may include a main body 100, a brush module 110, a gear box 120, a driving module 130, and a traveling module 140.

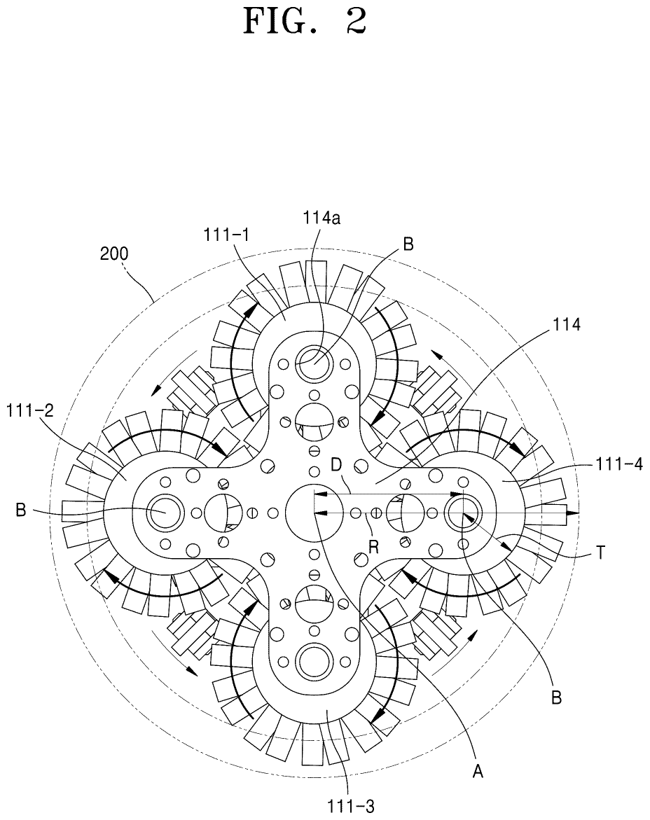

The main body 100 may form the framework of the pipe cleaning device 10. The main body 100 may be inserted into a pipe 200 (FIG. 2) and may move in a lengthwise direction (an X-axis direction) of the pipe 200. The main body 100 may have a shape corresponding to a shape of the pipe 200 and may be disposed inside the pipe 200 such that a central axis of the pipe 200 may coincide with a central axis of the main body 100.

According to some example embodiments, when the pipe 200 is a cylindrical pipe (e.g., a 100A pipe), the main body 100 may have a cylindrical shape that may be sized and shaped (or otherwise configured) to be inserted into the pipe 200. The main body 100 may be positioned inside the pipe 200 such that the central axis of the pipe 200 may coincide (or may be nearly coincident) with the central axis of the main body 100. For the sake of explanation, the central axis of the pipe 200 and the central axis of the main body 100 are illustrated as central axis A in FIG. 1.

The brush module 110 may be positioned toward the front or forward end of the main body 100 in a direction of forward movement of the main body 100, and may include a plurality of brushes 111, a first connecting member 112, a second connecting member 113, and a brush support plate 114. With reference to orientation FIG. 1, the forward movement of the main body 100 may be in the negative X-axis direction.

The plurality of brushes 111 may crush or break residue deposited on the inner wall of the pipe 200. Each of the plurality of brushes 111 may rotate and/or move about the central axis A in an orbital manner inside the pipe 200. A plurality of bristles 117 included in each of the plurality of brushes 111 may generate friction with the residue deposited on the inner wall of the pipe 200, remove or dislodge the residue from the inner wall of the pipe 200, and break down or crush the residue removed from the inner wall.

According to some example embodiments, each of the plurality of brushes 111 may rotate in a circumferential (or circular) direction about a brush central axis B of each of the plurality of brushes 111. Additionally or alternatively, each of the plurality of brushes 111 may rotate about the central axis A of the pipe 200 in a circumferential (or circular) direction of the pipe 200.

The plurality of bristles 117 included in each of the plurality of brushes 111 may protrude outward in a radial direction of the brush central axis B of each of the plurality of brushes 111. The brush central axis B of each of the plurality of brushes 111 may be parallel to the central axis A of the pipe 200 and the main body 100.

According to some example embodiments, and as illustrated, the brush module 110 may include four brushes 111 that may be arranged symmetrically with respect to each other. In some example embodiments, the brush module 110 may include a first brush 111-1, a second brush 111-2, a third brush 111-3, and a fourth brush 111-4, collectively referred to as brushes 111. The first brush 111-1 and the second brush 111-2 may be arranged symmetrically about a virtual center line between the first brush 111-1 and the second brush 111-2, the first brush 111-1 and the third brush 111-3 may be arranged symmetrically about a virtual center line between the first brush 111-1 and the third brush 111-3, and the first brush 111-1 and the fourth brush 111-4 may be arranged symmetrically about a virtual center line between the first brush 111-1 and the fourth brush 111-4.

The first connecting member 112 may form a first connection between a driven gear 124 and the brush 111. The number of first connecting members 112 may correspond to the number of driven gears 124 and/or brushes 111. For example, in FIG. 1, the number of first connecting members 112 is 4, each corresponding to a respective driven gear 124 and brush 111. The first connection based on the first connecting member 112 may transmit a rotational motion and/or an orbital motion of the driven gear 124 to the brush 111.

According to some example embodiments, the first connecting member 112 may be a shaft protruding (e.g., axially) forward from the driven gear 124. In some example embodiments, one end of the first connecting member 112 may be coupled with the driven gear 124, and the other opposite end of the first connecting member 112 may be coupled with the brush 111.

According to some example embodiments, the first connecting member 112 may further include a first joint 119. The first joint 119 may form or otherwise define an angle of the first connection between the brush 111 and the driven gear 124. The angle of the first connection (e.g., a first connection angle) refers to an angle between the center axis of the driven gear 124 and the brush central axis B of the brush 111.

The angle of the first connection may be changed within a preset angle range. The preset angle range may be determined based on the structure and/or type of the first joint and may also be determined based on the number of brushes 111. In some example embodiments, when the first joint is a universal joint and the number of brushes 111 is 4, the preset angle range may be between 0 degree (or about 0 degree) to 45 degrees (or about 45 degrees).

The second connecting member 113 may form a second connection between the brush 111 and a brush support plate 114. The number of second connecting member 113 may correspond to the number of brushes 111. For example, the brush module 110 of FIG. 1 includes 4 second connecting members 113 corresponding to 2 brushes 111. The second connection based on the second connecting member 113 may transmit an orbital motion of the brush 111 to the brush support plate 114.

According to some example embodiments, the second connecting member 113 may be a shaft connected to a front end of the brush 111. One end of the second connecting member 113 may be coupled with the front end of the brush 111, and the other opposite end of the second connecting member 113 may be inserted into an insertion groove 114a of the brush support plate 114 and coupled with the brush support plate 114.

According to some example embodiments, the second connecting member 113 may further include a second joint 133. The second joint 133 may form or otherwise define an angle of the second connection between the brush 111 and the brush support plate 114. The angle of the second connection refers to an angle between the brush central axis B of the brush 111 and a central axis A of the brush support plate 114. In some example embodiments, the angle of the second connection is the same (or about the same) as the angle of the first connection.

The brush support plate 114 may support the plurality of brushes 111 so that the plurality of brushes 111 may perform a rotational motion and/or an orbital motion while being inclined at the angle of the first connection and the angle of the second connection. The brush support plate 114 may include a plurality of insertion grooves 114a that may be sized or shaped or otherwise configured to couple with the second connecting member 113 in such a way that one end of the second connecting member 113 may be inserted into a corresponding insertion groove 114a.

According to some example embodiments, the second connecting member 113 may be cylindrical shaped and the other opposite end of the second connecting member 113 may be inserted into and coupled to the insertion groove 114a that may have a corresponding circular shape that may be sized or shaped or otherwise configured to receive the second connecting member 113. In some example embodiments, a bearing may be installed in the insertion groove 114a and the other opposite end of the second connecting member 113 may be inserted into an inner ring of the bearing, so that the second connecting member 113 and the insertion groove 114a may be coupled to each other. In some example embodiments, the second connecting member 113 and the insertion groove 114a may be coupled to each other by using one or more fasteners such as a flange, bolts, nuts, screws, clips, and the like. The second connecting member 113 and the insertion groove 114a may be coupled to each other in other ways that include different coupling structures through which the rotational motion of the plurality of brushes 111 may be transmitted to the brush support plate 114.

The gear box 120 may be interposed between the main body 100 and the brush module 110. In other words, the gear box 120 may be connected to a front end of the main body 100 and may be connected to a rear end of the brush module 110. The gear box 120 may include a sun gear 121, a ring gear 122, a plurality of planetary gears 123, a plurality of driven gears 124, a fixed plate 125, and a gear carrier 126.

The sun gear 121 is located at the center of the gear box 120, and the ring gear 122 may be formed along an inner circumferential surface of a protrusion included in the fixed plate 125. The plurality of planetary gears 123 may be positioned between the sun gear 121 and the ring gear 122 and may form meshing with the sun gear 121 and the ring gear 122.

According to some example embodiments, when the sun gear 121 is connected to the driving module 130 and receives the rotational driving force from the driving module 130, the sun gear 121 may operate as an input gear, the ring gear 122 may operate as a fixed or stationary gear, and the plurality of planetary gears 123 may operate as a plurality of output gears.

According to some example embodiments, when the ring gear 122 is connected to the driving module 130 and receives a rotational driving force from the driving module 130, the ring gear 122 may operate as an input gear, the sun gear 121 may operate as a fixed or stationary gear, and the plurality of planetary gears 123 may operate as a plurality of output gears.

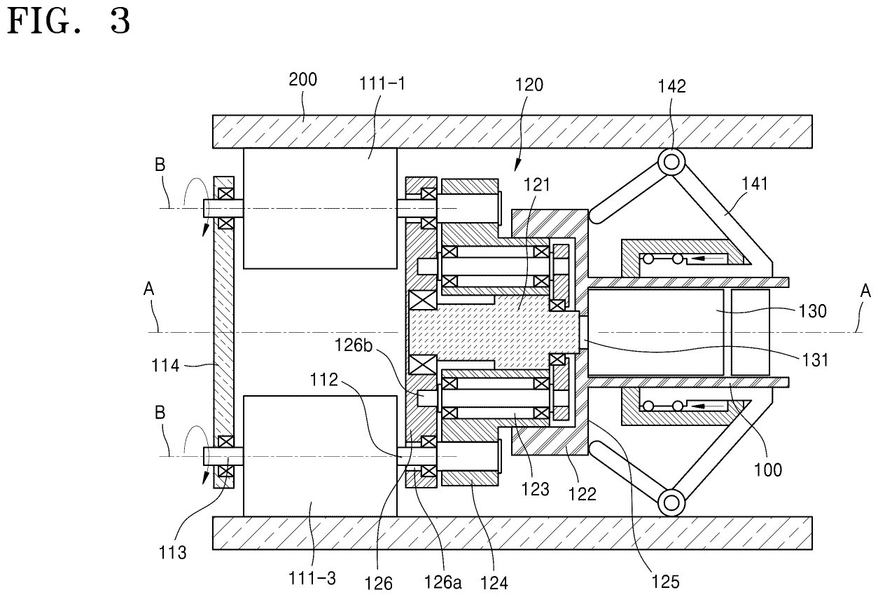

As described above, the sun gear 121, the ring gear 122, and the plurality of planetary gears 123 may perform a rotational motion and/or an orbital motion, based on the rotational driving force received from the driving module 130. Descriptions of the meshing, rotational motion, and orbital motion of the sun gear 121, the ring gear 122, and the plurality of planetary gears 123 are provided elsewhere in this document with reference to FIGS. 3 through 5.

The plurality of driven gears 124 may form a third meshing with the plurality of planetary gears 123, respectively. The third meshing may be a meshing of transmitting the rotational motion and/or the orbital motion of the planetary gears 123 to the driven gear 124. In other words, each of the plurality of driven gears 124 may receive power from each of the plurality of planetary gears 123, based on the third meshing.

A distance by which a central axis of the driven gear 124 is separated from the central axis of the pipe 200 may be greater than a distance by which a central axis of the planetary gear 123 is separated from the central axis of the pipe 200. In other words, the driven gears 124 may be positioned radially outside the planetary gears 123. The distance from the central axis of the pipe 200 refers to a distance from the central axis of the pipe 200 in the radial direction of the pipe 200.

As described above, because the driven gear 124 forms the third meshing while being located at a position further away from the central axis of the pipe 200 than the planetary gear 123, a rotational direction of the rotational motion of the driven gear 124 may be opposite to a rotational direction of the rotational motion of the planetary gear 123, and a rotational direction of the orbital motion of the driven gear 124 may be the same as a rotational direction of the orbital motion of the planetary gear 123.

According to some example embodiments, when each of the plurality of planetary gears 123 performs a rotational motion in a counterclockwise direction and performs an orbital motion in a clockwise direction, each of the plurality of driven gears 124 may perform a rotational motion and an orbital motion in a clockwise direction.

The fixed plate 125 may be located on an axial end (e.g., a lower end) of the gear box 120 and may be coupled to the front end of the main body 100. The fixed plate 125 may be shaped as a circular plate, and the fixed plate 125 may include a protrusion having a same thickness and a same height and positioned along the circumference of the circular plate. The ring gear 122 may be present on the inner circumferential surface of the protrusion of the fixed plate 125.

According to some example embodiments, the fixed plate 125 may be coupled to the front end of the main body 100 and may be stationary or fixed. The ring gear 122 formed on the fixed plate 125 may be stationary, and the fixed plate 125 may include a circular hole at the center of the fixed plate 125. The sun gear 121 may be connected to a rotating shaft that passes through the circular hole of the fixed plate 125 from the inside of the main body 100, and thus may receive a rotational driving force from the driving module 130.

According to some example embodiments, the fixed plate 125 may be coupled to the front end of the main body 100 and may rotate. The main body 100 is stationary in the circumferential direction of the pipe 200, while the fixed plate 125 may rotate in the circumferential direction of the pipe 200. In some example embodiments, the fixed plate 125 may be connected to the driving module 130 located inside the main body 100 to receive the rotational driving force, and accordingly, the ring gear 122 present on the inner circumferential surface of the protrusion of the fixed plate 125 may perform a rotational motion.

The gear carrier 126 (FIG. 3) is located on the fixed plate 125 and may support the plurality of driven gears 124. The gear carrier 126 may guide the rotational motion and the orbital motion of the plurality of driven gears 124 so that the third meshing may be maintained.

The gear carrier 126 may include a plurality of through grooves 126a and a plurality of connecting portions 126b. The first connecting member 112 may be connected to the brush 111 and may pass through the through groove 126a included in the gear carrier 126. The first connecting member 112 included in the gear carrier 126 may be connected to the planetary gear 123. As the gear carrier 126 is connected to the plurality of planetary gears 123 through the plurality of connecting portions 126b, the gear carrier 126 may rotate in the same rotational direction and at the same angular velocity as the orbital motion of the plurality of planetary gears 123. A structure including the gear carrier 126 connected to the plurality of planetary gears 123 and a structure including the first connecting member 112 penetrating through the through groove 126a will be described below with reference to FIG. 3.

The driving module 130 may be located inside the main body 100 and may provide a rotational driving force to the sun gear 121 and/or ring gear 122 included in the gear box 120. The driving module 130 may include a vane motor that is driven by pneumatic pressure or may include a motor that is driven by electric power.

According to some example embodiments, the driving module 130 may include a vane motor driven by pneumatic pressure. The driving module 130 may be connected to a pneumatic pressure generation device located outside the pipe 200 through a supply line, and may provide a rotational driving force to the input gear, based on pneumatic pressure received from the external pneumatic pressure generation device.

According to some example embodiments, the driving module 130 may include a motor that is driven by electric power. The driving module 130 may be connected to a power supply device located outside the pipe 200 or may receive power from a battery located inside the main body 100, thereby providing a rotational driving force to the input gear.

The above-described motors are merely examples of different embodiments of the driving module 130, and the driving module 130 may include different types of actuators that are configured to provide a rotational driving force.

The traveling module 140 may include a plurality of links 141 and a plurality of driving wheels 142 respectively coupled to the plurality of links 141. The plurality of links 141 may be coupled to an outer circumferential surface of the main body 100. The plurality of links 141 and the plurality of driving wheels 142 may drive the main body 100 in the lengthwise direction (e.g., axial direction) of the pipe 200 and/or may support the main body 100 so movement of the main body 100 inside the pipe 200 may be limited in the radial and/or circumferential directions of the pipe 200. Because the plurality of driving wheels 142 are arranged symmetrically about the central axis A of the pipe 200 and are all in close (or continuous) contact with the inner wall of the pipe 200, the main body 100 may be supported inside the pipe 200.

According to some example embodiments, the plurality of links 141 may be coupled to an elastic component (e.g., spring) that may cause the plurality of links 141 to move radially inward and outward inside the pipe 200 by either expanding or compressing. The plurality of links 141 may be displaced radially using the elastic component by a distance corresponding to the radius of the pipe 200, so that the plurality of driving wheels 142 coupled to the plurality of links 141 may be in close contact with the inner wall of the pipe 200. In some example embodiments, a radially outward force exerted by the elastic component may be larger than a compressive force that may act on the elastic component such that the plurality of links 141 are pushed radially outward and the plurality of driving wheels 142 are in continuous (or almost continuous) contact with the inner wall of the pipe 200.

According to some example embodiments, the plurality of links 141 may be coupled to an actuator that extends or retracts the plurality of links 141 in the radial direction of the pipe 200. The plurality of links 141 may be extended or retracted by the actuator by a length distance to the radius of the pipe 200, so that the plurality of driving wheels 142 may be in close (or continuous or near continuous) contact with the inner wall of the pipe 200.

The above-described method of contacting the plurality of driving wheels 142 to the inner wall of the pipe 200 is an example, and the plurality of driving wheels 142 may be contacted with the inner wall of the pipe 200 by using a variety of other methods, such as, by connecting both the elastic component and the actuator to the plurality of links 141, or using other techniques for radially displacing the plurality of links 141 (and thereby the plurality of driving wheels 142) depending on application and/or design.

The pipe cleaning device 10 according to some example embodiments of the inventive concepts may include the above-described components to thereby remove or dislodge the residue formed on the inner wall of the pipe 200 while moving (e.g., axially) inside the pipe 200.

FIG. 2 is a cross-sectional view of the pipe cleaning device 10 taken in a Y-axis direction, according to some example embodiments.

Referring to FIG. 2, the plurality of brushes 111 may have a rotational motion and an orbital motion and may generate friction (e.g., via the bristles 117) with residue formed on the inner wall of the pipe 200.

The pipe 200 may have a cylindrical shape and may connect semiconductor production equipment to a scrubber or connect a plurality of scrubbers to each other. The pipe 200 may be cylindrically shaped and may be formed having a range of different inner and outer radii. The pipe 200, according to some example embodiments, may be a 100A pipe. As indicated in FIG. 2, the inner radius of the pipe 200 may be represented as R.

Fluid may flow within the pipe 200. The fluid may include a byproduct and/or gas generated during any one of a photolithography process, an ion implantation process, a deposition process, an etching process, and a cleaning process in a semiconductor process. The fluid flowing in the pipe 200 may form residue, such as silicon powders, on the inner wall of the pipe 200 due to physical or chemical reactions. For example, the residue formed on the inner wall of the pipe 200 may include solid particles, such as silicon oxide.

As illustrated in FIG. 2, the brush central axis B of each of the plurality of brushes 111 may be positioned at a distance D from the central axis A of the pipe 200 in the radial direction of the pipe 200.

According to some example embodiments, the plurality of bristles 117 included in each of the plurality of brushes 111 may protrude from the brush central axis B in a radial direction from the brush central axis B. A length of each of the plurality of bristles 117 may be greater than or equal to a preset second distance. The length of each of the plurality of bristles 117 refers to a length by which each of the plurality of bristles 117 protrudes from the brush central axis B in the radial direction from the brush central axis B. As shown in FIG. 2, the length of each of the plurality of bristles may be represented as T.

The preset second distance refers to a difference between a radius of the pipe 200 and a distance between the brush central axis B and the central axis A of the pipe 200. As illustrated in FIG. 2, assuming that the brush central axis B is spaced apart from the central axis A of the pipe 200 by D, the preset second distance may be expressed as “R-D”.

Because the length of each of the plurality of bristles 117 is greater than or equal to the preset second distance, when the brush 111 performs a rotational motion and an orbital motion, the brush 111 may generate sufficient and/or desired friction with the inner wall of the pipe 200. Accordingly, the pipe cleaning device 10 may more effectively remove residue formed on the inner wall of the pipe 200.

According to some example embodiments, the length of each of the plurality of bristles 117 included in the brush 111 may be equal to or less than a preset third distance. The preset third distance may allow a plurality of bristles 117 included in a brush 111 to contact a plurality of bristles 117 included in another brush 111 adjacent to the brush 111.

It is assumed that the brush module 110 includes four brushes arranged to be mirror-symmetrical with each other as illustrated in FIG. 2. In this case, the first brush 111-1 and the second brush 111-2 may be arranged adjacent to each other, a distance between the central axis B of the first brush 111-1 and the central axis B of the second brush 111-2 may be \sqrt{2}D, and the preset third distance may be \sqrt{2}D.

Because the length of each of the plurality of bristles 117 is less than or equal to the preset third distance, when the brush 111 performs a rotational motion and an orbital motion, the plurality of bristles 117 included in the brush 111 may not contact the plurality of bristles 117 included in the other brush 111 adjacent to the brush 111. Accordingly, a plurality of brushes 111 may perform a rotational motion and an orbital motion without colliding with each other.

The rotational motion of the plurality of brushes 111 may remove residue formed on the inner wall of the pipe 200. Because the plurality of brushes 111 revolve about the central axis A of the pipe 200 in the circumferential direction of the pipe 200, the plurality of brushes 111 may generate friction with residue formed on the inner wall of the pipe 200, and the residue may be removed from the inner wall due to the friction.

The rotational motion of the plurality of brushes 111 may crush or break up the residue dislodged or removed from the inner wall of the pipe 200 into smaller pieces. For example, it is assumed that residue dislodged from the inner wall of the pipe 200 may fall between the first brush 111-1 and the second brush 111-2, and the plurality of bristles 117 included in the first brush 111-1 and the plurality of bristles 117 included in the second brush 111-2 contact each other. Because both the first brush 111-1 and the second brush 111-2 rotate in the same rotational direction (e.g., clockwise in FIG. 2), the rotational motion of the first brush 111-1 may cause the plurality of bristles 1117 of the first brush 111-1 to push or displace the fallen residue toward the center of the pipe 200, and the rotational motion of the second brush 111-2 may cause the plurality of bristles 117 of the second brush 111-2 to push or displace the fallen residue toward the inner wall of the pipe 200. The residue located between the first brush 111-1 and the second brush 111-2 may be broken part into small pieces due to forces in different directions respectively transmitted by the first brush 111-2 and the second brush 111-2.

The brush support plate 114 may be connected to each of the plurality of brushes 111, based on the second connection by the second connecting member 113. The second connection may be a connection configured to transmit an orbital motion of each of the plurality of brushes 111 to the brush support plate 114. In detail, because the second connecting member 113 may be inserted into the insertion groove 114a and coupled to the brush support plate 114 and may be connected to one end of the plurality of brushes 111 and perform the same orbital motion as the plurality of brushes 111, the brush support plate 114 may also perform a rotational motion corresponding to the orbital motion of the second connecting member 113. The brush support plate 114 may rotate about the central axis A of the pipe 200 in the circumferential direction of the pipe 200.

FIG. 3 is a schematic cross-sectional view of the pipe cleaning device 10 located in the pipe 200 taken in an X-axis direction in FIG. 1, according to some example embodiments.

According to some example embodiments, the sun gear 121 may operate as a fixed or stationary gear and the ring gear 122 may operate as an input gear. However, in the description of FIG. 3, this configuration of the sun gear 121 operating as an input gear and the ring gear 122 operating as a fixed or stationary gear is merely an example that is discussed for the convenience of explanation. Other configurations are also possible.

Referring to FIG. 3, the sun gear 121 may be located at the center of the fixed plate 125 and connected to a rotating shaft 131 that passes through the fixed plate 125, and thus may receive a rotational driving force from the driving module 130. The ring gear 122 may be located on the inner circumferential surface of the protrusion formed along the circumference of the fixed plate 125 and may be stationary. The plurality of planetary gears 123 may be positioned between the sun gear 121 and the ring gear 122, and each of the plurality of planetary gears 123 may form a first meshing with the sun gear 121 and form a second meshing with the ring gear 122. Each of the plurality of planetary gears 123 may form the third meshing with each of the plurality of driven gears 124.

According to some example embodiments, the first meshing may be a meshing formed at a first level, the second meshing may be a meshing formed at a second level, and the third meshing may be a meshing formed at a third level. The first level may be a section where gear teeth of the sun gear 121 overlap those of the plurality of planetary gears 123, the second level may be a section where gear teeth of the ring gear 122 overlap those of the plurality of planetary gears 123, and the third level may be a section where gear teeth of the plurality of driven gears 124 overlap those of the plurality of planetary gears 123.

When the gear teeth of the sun gear 121 may be present in a length section 5 cm (or about 5 cm) to 15 cm (or about 15 cm) away from the fixed plate 125 in the lengthwise direction (X-axis direction) of the pipe 200 and the gear teeth of the plurality of planetary gears 123 may be present in a length section 5 cm (or about 5 cm) to 25 cm (or about 25 cm) away from the fixed plate 125 in the lengthwise direction of the pipe 200, the first level may be a length section 5 cm (or about 5 cm) to 15 cm (or about 15 cm) away from the fixed plate 125.

According to some example embodiments, the first level and the second level may include overlapping sections, and the first level and the second level may not overlap each other in the third level. The third level may be a section further away (e.g., axially) from the fixed plate 125 than the first level and the second level. Through this arrangement, the plurality of planetary gears 123 may perform a rotational motion by receiving power from the sun gear 121 based on the first meshing formed at the first level, and may perform an orbital motion based on the rotational motion performed by the second meshing formed at the second level and the received power. The plurality of planetary gears 123 may transmit power to the plurality of driven gears 124, based on the third meshing formed at the third level where the first level and the second level do not overlap each other.

As described above, as the plurality of planetary gears 123 form different meshings at different levels, the plurality of planetary gears 123 may efficiently receive power from other gears and efficiently provide power to other gears.

As illustrated in FIG. 3, the planetary gear 123 is implemented as an integrated gear, and thus may form the first meshing and the second meshing on a lower end of the integrated gear and form the third meshing on an upper end of the integrated gear. However, this configuration of the planetary gear 123 is merely an example and the planetary gear 123 may be implemented as a gear having a structure configured of forming different meshings at various levels with a plurality of gears, such as, being implemented as a first-stage gear and a second-stage gear having the same axis.

The plurality of driven gears 124 may receive power from the plurality of planetary gears 123, respectively, based on the third meshing, and may perform a rotational motion and an orbital motion. The plurality of driven gears 124 may be supported by the gear carrier 126.

The gear carrier 126 may be connected to respective first ends of the plurality of planetary gears 123 via the plurality of connecting portions 126b. The gear carrier 126 may receive the orbital motion of the plurality of planetary gears 123 by being connected to the respective first ends of the plurality of planetary gears 123, and may perform a rotational motion in the same rotational direction and at the same angular velocity as the orbital motion of the plurality of planetary gears 123.

The gear carrier 126 may include the plurality of through grooves 126a, and the plurality of through grooves 126a may allow the plurality of first connecting members 112 to pass through the gear carrier 126 and form couplings with respective one ends of the plurality of brushes 111.

As the brush 111 and the driven gear 124 are connected to each other through the first connecting member 112, the brush 111 may perform a rotational motion in the same rotational direction and at the same angular velocity as the rotational motion of the driven gear 124, and the brush 111 may perform an orbital motion in the same rotational direction and at the same angular velocity as the orbital motion of the driven gear 124.

According to some example embodiments, unlike FIG. 3, the pipe cleaning device 10 may not include the second connecting member 113 and the brush support plate 114. Because the brush support plate 114 for fixing and supporting the brush 111 may not be included, the plurality of brushes 111 may be connected to the side (e.g., front side) of the gear box 120 by the first connecting member 112 and supported by the connection with the gear box 120. The first connecting member 112 may include a joint, and the joint may form a connecting angle between the plurality of driven gears 124 and the plurality of brushes 111. The connecting angle between the plurality of driven gears 124 and the plurality of brushes 111 may be variable within a preset angle range.

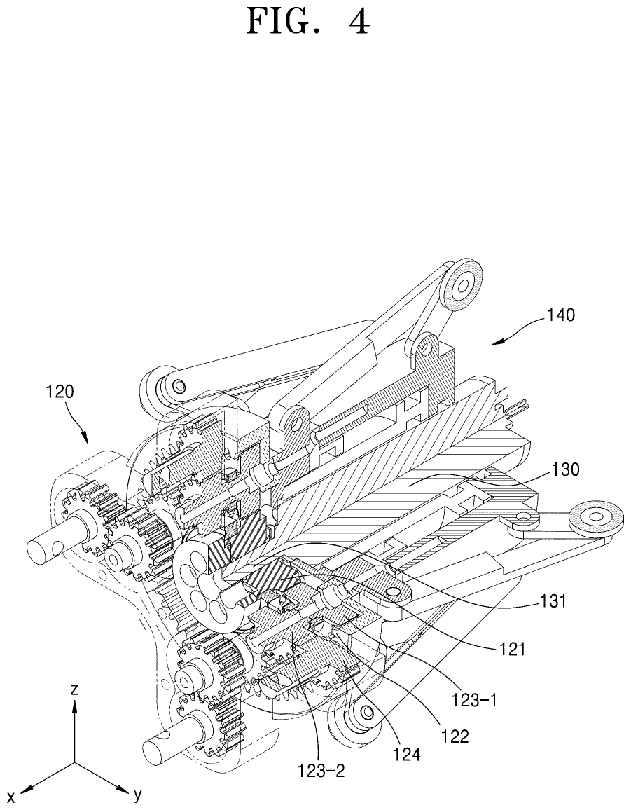

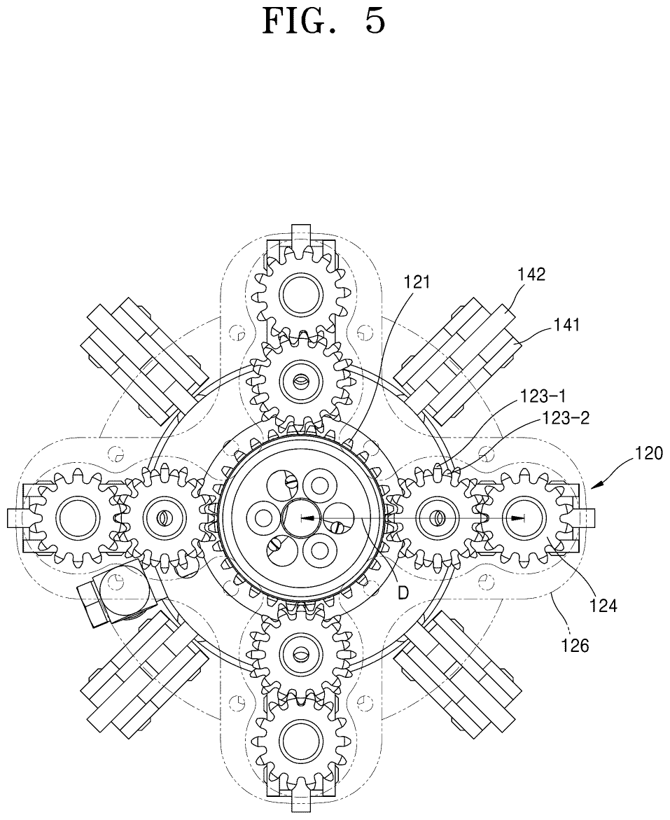

FIG. 4 is a cut-out perspective view of the gear box 120 of a pipe cleaning device 10, according to some example embodiments. FIG. 5 is a cross-sectional view of the gear box 120 of the pipe cleaning device 10 taken in the Y-axis direction, according to some example embodiments.

Referring to FIGS. 4 and 5, the gear box 120 may include a plurality of gears forming first meshing, second meshing, and third meshing, the fixed plate 125, and the gear carrier 126.

According to some example embodiments, the sun gear 121 may operate as an input gear, the ring gear 122 may be a fixed or stationary gear, and the plurality of planetary gears 123 may operate as a plurality of output gears. The sun gear 121 may be coupled to the outer circumferential surface of the rotating shaft 131 connected to the driving module 130. Through this structure, the sun gear 121 may perform a rotational motion by receiving a rotational driving force from the driving module 130.

Each of the plurality of planetary gears 123 may perform a rotational motion by receiving power from the sun gear 121 based on the first meshing with the sun gear 121. The rotational direction of the rotational motion of each of the plurality of planetary gears 123 is opposite to the rotational direction of the rotational motion of the sun gear 121. Each of the plurality of planetary gears 123 may perform an orbital motion, based on the second meshing with the ring gear 122 and the rotational motion of each of the plurality of planetary gears 123. The rotational direction of the orbital motion of each of the plurality of planetary gears 123 may be the same as the rotational direction of the rotational motion of the sun gear 121.

Each of the plurality of driven gears 124 may receive power, based on the third meshing formed with each of the plurality of planetary gears 123, and may perform a rotational motion and an orbital motion. The rotation direction of the rotational motion of each of the plurality of driven gears 124 may be the same as that of the rotational motion of the sun gear 121, and the rotation direction of the orbital motion of each of the plurality of driven gears 124 may be the same as that of the rotational motion of the sun gear 121.

Each of the plurality of brushes 111 may form a first connection based on the first connecting member 112 with each of the plurality of driven gears 124, and the first connection may enable each of the plurality of brushes 111 to perform the same type of rotational motion and orbital motion as each of the plurality of driven gears 124. Accordingly, the rotation direction of the rotational motion of each of the plurality of brushes 111 may be the same as that of the rotational motion of the sun gear 121, and the rotation direction of the orbital motion of each of the plurality of brushes 111 may be the same as that of the rotational motion of the sun gear 121.

For example, when the rotation direction of the sun gear 121 is clockwise, the rotational direction of each of the plurality of planetary gears 123 is counterclockwise, and the orbital direction of each of the plurality of planetary gears 123 is clockwise. The rotational direction and orbital direction of each of the plurality of driven gears 124 are clockwise, and the rotational direction and orbital direction of each of the plurality of brushes 111 are also clockwise.

According to some example embodiments, the sun gear 121 may be a fixed or stationary gear, the ring gear 122 may operate as an input gear, and the plurality of planetary gears 123 may operate as a plurality of output gears. The ring gear 122 may be coupled to one surface (e.g., the outer circumferential surface) of the rotating shaft 131 connected to the driving module 130. Through this structure, the ring gear 122 may perform a rotational motion by receiving a rotational driving force from the driving module 130.

Each of the plurality of planetary gears 123 may rotate by receiving power from the ring gear 122 based on the first meshing with the ring gear 122. The rotational direction of the rotational motion of each of the plurality of planetary gears 123 may be the same as that of the rotational motion of the ring gear 122. Each of the plurality of planetary gears 123 may perform an orbital motion based on the second meshing with the sun gear 121 and the rotational motion of each of the plurality of planetary gears 123. The rotational direction of the orbital motion of each of the plurality of planetary gears 123 may be the same as that of the rotational motion of the ring gear 122.

Each of the plurality of driven gears 124 may receive power, based on the third meshing formed with each of the plurality of planetary gears 123, and may perform a rotational motion and an orbital motion. At this time, the rotation direction of the rotational motion of each of the plurality of driven gears 124 is opposite to that of the rotational motion of the ring gear 122, and the rotation direction of the orbital motion of each of the plurality of driven gears 124 may be the same as that of the rotational motion of the ring gear 122.

Accordingly, the rotation direction of the rotational motion of each of the plurality of brushes 111 is opposite to that of the rotational motion of the ring gear 122, and the rotation direction of the orbital motion of each of the plurality of brushes 111 may be the same as that of the rotational motion of the ring gear 122.

For example, when the rotation direction of the ring gear 122 is clockwise, the rotational direction of each of the plurality of planetary gears 123 is clockwise, and the orbital direction of each of the plurality of planetary gears 123 is clockwise. The rotational direction of each of the plurality of driven gears 124 is counterclockwise, and the orbital direction of each of the plurality of driven gears 124 are clockwise. Accordingly, the rotational direction of each of the plurality of brushes 111 is counterclockwise, and the orbital direction of each of the plurality of brushes 111 is clockwise.

Referring to FIG. 4 the plurality of planetary gears 123 may include a first stage gear 123-1 and a second stage gear 123-2 arranged adjacent each other. A central axis of the first stage gear 123-1 and the second stage gear 123-2 may be the same. The first stage gear 123-1 may form a first meshing at the first level and a second meshing at the second level, and the second stage gear 123-2 may form a third meshing at the third level.

According to some example embodiments, when the sun gear 121 operates as an input gear and the ring gear 122 is a fixed or stationary gear, the first stage gear 123-1 may form a first meshing with the sun gear 121 at the first level and a second meshing with the ring gear 122 at the second level. In this case, the second stage gear 123-2 may form the third meshing with the driven gear 124 at the third level.

According to some example embodiments, when the ring gear 122 is an input gear and the sun gear 121 is a fixed or stationary gear, the first stage gear 123-1 may form a first meshing with the ring gear 122 at the first level and a second meshing with the sun gear 121 at the second level. In this case, the second stage gear 123-2 may form the third meshing with the driven gear 124 at the third level.

With reference to a forward direction (negative X direction in FIG. 1) of the main body 100, the first stage gear 123-1 may be located behind the second gear 123-2, which may be located in front of the first stage gear 123-1. In some example embodiments, each planetary gear 123 may be implemented as an integrated gear.

The central axis of each of the plurality of driven gears 124 may be spaced apart from the central axis A of the main body 100 (and pipe 200) by a preset first distance in the radial direction of the pipe 200. As shown in FIG. 5, the preset first distance may be expressed as D.

The preset first distance may be a distance obtained by adding a radius of the planetary gear 123 and a radius of the driven gear 124 to a distance from the central axis A of the main body 100 (and pipe 200) to the central axis of the planetary gear 123.

As shown in FIGS. 4 and 5, a plurality of gears included in the gear box 120 may form a first meshing, a second meshing, and a third meshing to transmit power, so that the plurality of brushes 111 performs a rotational motion and an orbital motion, thereby more effectively removing residue formed on the inner wall of the pipe 200.

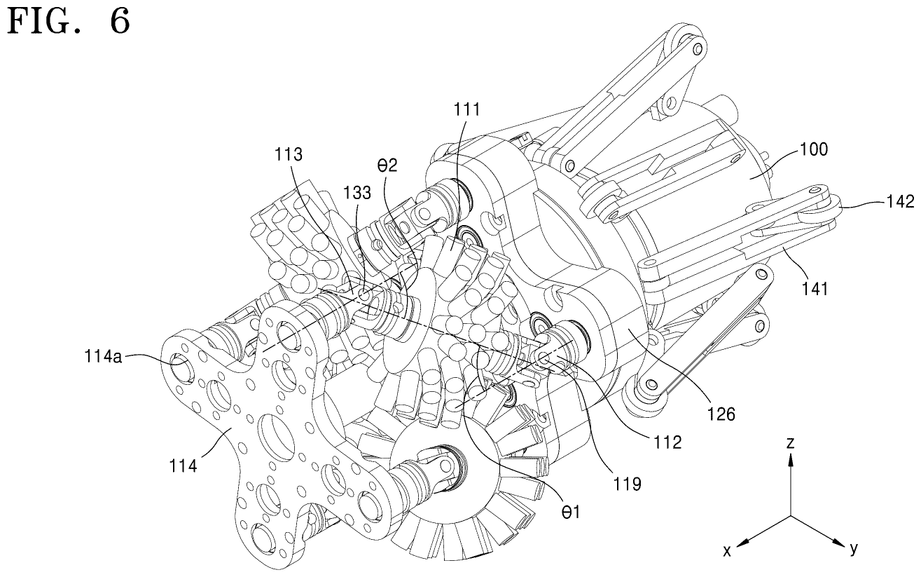

FIG. 6 is a perspective view showing angles of the first connection and the second connection of the pipe cleaning device 10, according to some example embodiments.

Referring to FIG. 6, the first connecting member 112 and the second connecting member 113 may include the first joint 119 and the second joint 133, respectively. The angle Θ1 of the first connection and the angle Θ2 of the second connection may be between 0 to 45 degrees (or about 45 degrees).

Each of the plurality of brushes 111 included in the pipe cleaning device 10, according to some example embodiments, may perform a rotational motion and an orbital motion while being tilted or inclined at the angle of the first connection and the angle of the second connection. The angle of the first connection and the angle of the second connection may be the same as each other. By performing a rotational motion and an orbital motion while being tilted or inclined at a certain or desired angle, each of the plurality of brushes 111 may more effectively break up residue formed on the inner wall of the pipe 200.

Although FIG. 6 illustrates that the pipe cleaning device 10 includes the plurality of links 141 and the plurality of driving wheels 142, the pipe cleaning device 10 according to some example embodiments may not include the traveling module 140. When the pipe cleaning device 10 does not include the traveling module 140, the main body 100 may travel within the pipe 200, based on a frictional force between the plurality of brushes 111 and the inner wall of the pipe 200. Because the plurality of brushes 111 perform a rotational motion and an orbital motion while being inclined at the angle of the first connection with respect to the central axis A of the pipe 200, the frictional force between the plurality of brushes 111 and the inner wall of the pipe 200 may enable the main body 100 to travel or move forward or backward.

As described above in the description of FIG. 2, a length of each of the plurality of bristles 117 included in the plurality of brushes 111 may be greater than or equal to a preset second distance, so the plurality of brushes 111 may generate a sufficient and/or desired friction with the inner wall of the pipe 200. The angle of the first connection and the angle of the second connection may be set to 30 degrees (or about 30 degrees) to 45 degrees (or about 45 degrees) or more, so that the main body 100 may travel with relative less resistance in the lengthwise (or axial) direction of the pipe 200.

When the angle of the first connection and the angle of the second connection are less than 30 degrees (or about 30 degrees), a friction angle at which the plurality of bristles 117 included in the plurality of brushes 111 rub against the inner wall of the pipe 200 may not be effective for a forward/backward movement of the main body 100.

When the angle of the first connection and the angle of the second connection exceeds 45 degrees (or about 45 degrees), the rotational motion and the orbital motion of the plurality of brushes 111 may not impeded. A situation may occur in which the plurality of bristles 117 included in the plurality of brushes 111 are located at a position that may cause friction (e.g., increased friction) with the inner wall of the pipe 200. Accordingly, the angle of the first connection and the angle of the second connection greater than 45 degrees (or about 45 degrees) may not be effective for the forward and/or backward movement of the main body 100.

Accordingly, providing each of the angle of the first connection and the angle of the second connection between 30 degrees (or about 30 degrees) to 45 degrees (or about 45 degrees) may permit a forward and/or backward movement of the main body 100 within the pipe 200 with relative ease.

As described above, when the plurality of brushes 111 are used traveling or propelling the main body 100, the plurality of driving wheels 142 may support the pipe cleaning device 10 such that the pipe cleaning device 10 is located at or about the center of the pipe 200, or may support the traveling or movement of the main body 100 based on the rotation of the plurality of brushes 111.

According to some example embodiments, when the sun gear 121 operates as an input gear and the sun gear 121 rotates clockwise, the main body 100 may move or travel forward (in a +X-axis direction) within the pipe 200. On the contrary, when the sun gear 121 rotates counterclockwise, the main body 100 may move or travel backward (in a −X-axis direction) within the pipe 200. According to some example embodiments, when the sun gear 121 rotates counterclockwise, the main body 100 may move or travel forward, and, when the sun gear 121 rotates clockwise, the main body 100 may move or travel backward.

According to some example embodiments, when the ring gear 122 operates as an input gear and the ring gear 122 rotates clockwise, the main body 100 may move or travel forward within the pipe 200. At this time, when the ring gear 122 rotates counterclockwise, the main body 100 may move or travel backward within the pipe 200.

As described above, because whether the main body 100 moves forward or backward is determined according to the rotation direction of the input gear, the pipe cleaning device 10 may determine the traveling direction of the main body 100 by changing the direction of a rotational driving force provided to the input gear by the driving module 130.

While several embodiments have been provided in the present disclosure, it should be understood that the disclosed systems might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

What is claimed is:

1. A pipe cleaning device, comprising:
a main body configured to move inside a pipe in an axial direction of the pipe;
a brush module at a front of the main body and including a plurality of brushes and a plurality of connecting members;
a gear box between the main body and the brush module; and
a driving module at least partially within the main body and configured to provide a rotational driving force to the gear box, wherein
the gear box includes an input gear, a stationary gear, a plurality of output gears, and a plurality of driven gears,
the input gear configured to rotate based on the rotational driving force received from the driving module,
the plurality of output gears are configured to form a first meshing with the input gear and a second meshing with the stationary gear,
the plurality of output gears are configured to rotate in response to power received from the input gear based on the first meshing, and are configured to orbit about the main body based on the second meshing and a rotation of the plurality of output gears,
each of the plurality of driven gears is configured to form a third meshing with a corresponding one of the plurality of output gears, and is configured to receive power from a corresponding one of the plurality of output gears based on the third meshing to rotate and move orbitally, and
each of the plurality of brushes is configured to connect using a corresponding one of the plurality of connecting members to a corresponding one of the plurality of driven gears, is configured to rotate in a same rotational direction and at a same angular velocity as the plurality of driven gears, and is configured to orbit in a same rotational direction and at a same angular velocity as the plurality of driven gears.

2. The pipe cleaning device of claim 1, wherein
the input gear is a sun gear, the stationary gear is a ring gear, and the plurality of output gears are a plurality of planetary gears,
the ring gear is configured to couple to one end of the main body and is stationary,
the sun gear is configured to connect to the driving module and is configured to receive the rotational driving force,
each of the plurality of brushes rotate in a same direction as the sun gear, and
each of the plurality of brushes move orbitally in a same direction as the sun gear.

3. The pipe cleaning device of claim 1, wherein
the input gear is a ring gear, the stationary gear is a sun gear, and the plurality of output gears are a plurality of planetary gears,
the ring gear is configured to connect to the driving module and is configured to receive the rotational driving force,
the rotational direction of each of the plurality of brushes is opposite to the rotational direction of the ring gear, and
a direction of orbital movement of each of the plurality of brushes is a same as a direction of rotation of the ring gear.

4. The pipe cleaning device of claim 1, wherein
each of the plurality of output gears includes a first stage gear and a second stage gear that are adjacent each other,
a central axis of the first stage gear coincides with a central axis of the second stage gear,
the first stage gear is configured to form the first meshing and the second meshing, and
the second stage gear is configured to form the third meshing.

5. The pipe cleaning device of claim 4, wherein
a central axis of each of the plurality of driven gears is spaced apart from a central axis of the main body by a first distance in a radial direction of the main body, and
the first distance is obtained by adding a radius of the plurality of output gears and a radius of the plurality of driven gears to a distance from the central axis of the main body to the central axis of each of the plurality of output gears.

6. The pipe cleaning device of claim 4, wherein
the gear box further includes a gear carrier,
the gear carrier includes a plurality of through holes, each through hole of the plurality of through holes includes a corresponding one of a plurality of connecting members that are connected to a corresponding one of the plurality of driven gears,
the gear carrier is configured to connect to the second stage gear of each of the plurality of output gears and is configured to move orbitally in a same rotational direction and at a same angular velocity as the plurality of output gears, and
the gear carrier is configured to support the plurality of driven gears so that each of the plurality of driven gears rotates and moves in an orbital motion while maintaining the third meshing.

7. The pipe cleaning device of claim 1, wherein
each of the plurality of connecting members includes a joint,
each joint defines a connection angle between a corresponding driven gear of the plurality of driven gears and a corresponding brush of the plurality of brushes, and
the connection angle ranges from 0 degrees to 45 degrees.

8. The pipe cleaning device of claim 1, wherein
each of the plurality of brushes includes a plurality of bristles each protruding radially from a brush central axis,
a length of each of the plurality of bristles is greater than or equal to a second distance, and
the second distance is a difference between a radius of the pipe including the pipe cleaning device and a distance between the brush central axis and a central axis of the main body.

9. The pipe cleaning device of claim 1, wherein
the plurality of brushes include four brushes, and
the four brushes are arranged in mirror symmetry to each other.

10. A pipe cleaning device comprising:
a main body configured to move inside a pipe in an axial direction of the pipe;
a gear box coupled to an end of the main body;
a brush module at a front end of the gear box and including a plurality of brushes, a first connecting member, a second connecting member, and a brush support plate; and
a driving module configured to provide a rotational driving force to the gear box, wherein
the gear box includes an input gear, a stationary gear, a plurality of output gears, and a plurality of driven gears,
the input gear is configured to rotate in response to the rotational driving force received from the driving module,
the plurality of output gears, each configured to form a first meshing with the input gear and form a second meshing with the stationary gear,
the plurality of output gears are configured to rotate based on the first meshing, and move in an orbital motion based on the second meshing and a rotation of the plurality of output gears,
each of the plurality of driven gears is configured to form a third meshing with a corresponding one of the plurality of output gears and configured to receive power from each of the plurality of output gears to rotate and move in an orbital motion,
the first connecting member is configured to form a first connection between one end of each of the plurality of brushes and each of the plurality of driven gears, and the second connecting member is configured to form a second connection between another end of each of the plurality of brushes and the brush support plate, and
each of the plurality of brushes is configured to rotate in a same rotational direction and at a same angular velocity as the plurality of driven gears, and is configured to move in an orbital motion in a same direction and at a same angular velocity as the plurality of driven gears.

11. The pipe cleaning device of claim 10, wherein
the first connection is configured to transmit the rotation and the orbital motion of each of the plurality of driven gears to each of the plurality of brushes,
the second connection is configured to transmit the orbital motion of the plurality of brushes to the brush support plate,
a first angle of the first connection is defined between a central axis of each of the plurality of brushes and a central axis of the plurality of driven gears, and a second angle of the second connection is defined between the central axis of each of the plurality of brushes and a central axis of the brush support plate, and
the first angle and the second angle are same.

12. The pipe cleaning device of claim 11, wherein
each of the plurality of brushes is configured to rotate and move in an orbital motion while being inclined at the first angle with respect to the central axis of the pipe,
each of the plurality of brushes rotates about the central axis of each of the plurality of brushes, and
each of the plurality of brushes moves in the orbital motion about the central axis of the main body.

13. The pipe cleaning device of claim 12, wherein the first angle and the second angle are each between 30 degrees to 45 degrees.

14. The pipe cleaning device of claim 13, wherein, the main body moves forward or backward based on a direction of rotation of the input gear.

15. The pipe cleaning device of claim 10, wherein
the input gear is a sun gear, the stationary gear is a ring gear, and the plurality of output gears are a plurality of planetary gears,
the ring gear is coupled to an end of the main body and is stationary,
the sun gear is connected to the driving module and configured to receive the rotational driving force,
a rotational direction of each of the plurality of brushes is same as a rotational direction of the sun gear, and
a direction of the orbital motion of each of the plurality of brushes is same as the rotational direction of the sun gear.

16. The pipe cleaning device of claim 10, wherein
the input gear is a ring gear, the stationary gear is a sun gear, and the plurality of output gears are a plurality of planetary gears,
the ring gear is connected to the driving module and is configured to receive the rotational driving force,
the rotational direction of each of the plurality of brushes is opposite to the rotational direction of the ring gear, and
the direction of the orbital motion of each of the plurality of brushes is same as the rotational direction of the ring gear.

17. The pipe cleaning device of claim 10, wherein
each of the plurality of output gears includes a first stage gear and a second stage gear that are adjacent each other,
a central axis of the first stage gear coincides with a central axis of the second stage gear,
the first stage gear is configured to form the first meshing and the second meshing,
the second stage gear is configured to form the third meshing,
a central axis of each of the plurality of driven gears is spaced apart from a central axis of the main body by a first distance in a radial direction of the main body, and
the first distance is obtained by adding a radius of the plurality of output gears and a radius of the plurality of driven gears to a distance from the central axis of the main body to the central axis of each of the plurality of output gears.

18. The pipe cleaning device of claim 17, wherein
the gear box further includes a gear carrier,
the gear carrier includes a plurality of through holes, each through hole of the plurality of through holes includes a corresponding one of a plurality of connecting members that are connected to a corresponding one of the plurality of driven gears,
the gear carrier is configured to connect to the second stage gear of each of the plurality of output gears and is configured to move orbitally in a same rotational direction and at a same angular velocity as the plurality of output gears, and
the gear carrier is configured to support the plurality of driven gears so that each of the plurality of driven gears rotates and moves in an orbital motion while maintaining the third meshing.

19. The pipe cleaning device of claim 10, wherein
each of the plurality of brushes includes a plurality of bristles each protruding in a radial direction from a brush central axis,
a length of each of the plurality of bristles is greater than or equal to a second distance, and
the second distance is a difference between a radius of the pipe including the pipe cleaning device and a distance between the brush central axis and a central axis of the main body.

20. A pipe cleaning device comprising:
a main body;
a traveling module configured to move the main body within a pipe in an axial direction of the pipe;
a brush module in a front of the main body and including a plurality of brushes, a first connecting member, a second connecting member, and a brush support plate;
a gear box connected to the front of the main body and a rear of the brush module; and
a driving module at least partially within the main body and configured to provide a rotational driving force to the gear box, wherein
the gear box includes a stationary plate, a sun gear, a ring gear, a plurality of planetary gears, and a plurality of driven gears,
the stationary plate is coupled to the front of the main body and is stationary,
the ring gear is on an inner circumferential surface of a protrusion of the stationary plate and is stationary,
the sun gear is connected to the driving module by a rotating shaft passing through the stationary plate, and the sun gear is configured to rotate based on the rotating driving force,
the plurality of planetary gears are configured to form a first meshing with the sun gear and are configured to form a second meshing with the ring gear, are configured to rotate based on the first meshing, and are configured to move orbitally based on a rotation of the plurality of planetary gears and the second meshing,
each of the plurality of driven gears respectively configured to form a third meshing with the plurality of planetary gears, and configured to receive power from each of the plurality of planetary gears to rotate and move in an orbital motion,
the first connecting member is configured to form a first connection between a first end of each of the plurality of brushes and a corresponding one of the plurality of driven gears, and the second connecting member is configured to form a second connection between a second end of each of the plurality of brushes and the brush support plate, and
each of the plurality of brushes is configured to rotate in a same rotational direction and at a same angular velocity as the plurality of driven gears, and is configured to move in an orbital motion in a same direction and at a same angular velocity as the orbital motion of the plurality of driven gears.
